(19) United States
(12) Patent Application Publication
(10) Pub. No.: US 2002/0067606 A1
(43) Pub. Date: Jun. 6, 2002

(54) Dimmer light utilizing light-emitting disk

(75) Inventors: Shaw-Jong Wang, Hsinchu (TW); Joseph Shen, Taipei (TW); Chien-Hua Wu, Tou Fang (TW); Charen Yu, Taipei (TW)

Correspondence Address: FINNEGAN, HENDERSON, FARABOW, GARRETT &, DUNNER LLP, 1300 I STREET, NW, WASHINGTON, DC, 20005, US

(73) Assignee: Ritex Corporation.

(21) Appl. No.: 09/805,033

(22) Filed: Mar. 14, 2001

(30) Foreign Application Priority Data
Dec. 6, 2000 (TW) 89221188

(51) Int. Cl. F21V 9/16

(52) U.S. Cl. 362/84; 362/226; 362/253

(57) ABSTRACT

The present invention relates to a dimmer light for use with a light-emitting disk. The present invention not only has the same function with prior art dimmer lights, but also makes a convenience for users to collect and store light-emitting disks. Besides, the present invention increases functions of dimmer lights through developments of the light-emitting disk lighting partially, intermittently, or with different colors. The light-emitting disk and the dimmer light can be further grouped into a special modeling, such as a clock design. Furthermore, the present invention can increase other functions, such as a perfume box, to attract customers' interest and purchasing desire.

### BACKGROUND OF THE INVENTION

1. Field of the Invention

The present invention relates to a dimmer light, and particularly to a dimmer light utilizing a light-emitting disk.

2. Description of Related Art

Compact disks have been extensively used as a medium for recording video, audio and digital data. Usually, a readable surface containing data read by a laser is on one side of the compact disk, and a transparent protective layer is used to cover the readable surface. In addition, a lot of patterns are printed on the other side of the compact disk for marking the content of the compact disk and enriching the vision feeling of the compact disk. As the medium and advertisement progress, a purely planar printing cannot draw an attraction by people gradually and lose its appreciation is purpose. U.S. application Ser. No. 09/399,326 by one primary inventor of the present invention, entitled “Disk with Light Emitting,” disclosed a light-emitting disk containing a compact disk portion and an electro luminescent (EL) portion. The compact disk portion includes a substrate on which digital data is recorded. The EL portion can luminesce by applying external electricity. The compact disk can be a CD-ROM, CD-R, CD-RW, DVD-ROM, DVD-R, DVD-RW and MD, etc., and has a hole for being fixed and rotated by a disk carrier.

Because the light-emitting disk utilizes prior manufacturing processes and increases a special lighting function, people will be more interested in collecting these kinds of products. In addition, the light-emitting disk can be designed to emit light partially, intermittently, and with various colors.

Besides, since a dimmer light can emit a small amount of light in dark as a temporary guide, and it has been extensively used in corridors and small rooms. Prior dimmer lights mostly used an incandescent lamp as a light source. As an EL lamp is developed, few products used the EL lamp as a dimmer light. The EL lamp has advantages of long life, little power consumption and safety. ROC application No. 89214554, entitled “Ultra-Thin Dimmer Light,” disclosed an ultra-thin dimmer light having a simple structure and utilizing an EL lamp as a light source.

Since the prior art light-emitting disk does not disclose a carrier, the function of fixing and guidance in dark cannot be developed. Besides, the above dimmer light is a purely illuminating device, and lacks the function of reserving CD. Therefore, how to combine a light-emitting disk and a dimmer light into a device for collecting CD more easily, creating a second function of compact disks and owning beauty of sense and illumination in dark is an important issue.

### SUMMARY OF THE INVENTION

A first object of the present invention is to propose a dimmer light utilizing a light-emitting disk, which not only has the same function with prior art dimmer light, but also makes a convenience for users to collect and store light-emitting disks.

A second object of the present invention is to increase functions of dimmer lights through developments of the light-emitting disk emits light from a part of the disk, an intermittent light, or lights of different colors. The light-emitting disk and the dimmer light are combined into a special design (such as a clock design) for inducing customers' interest and purchasing desire.

For achieving the above objects, the present invention proposes a dimmer light for use with a light-emitting disk. The present invention comprises a light-emitting disk and a socket. The light-emitting disk includes a readable surface and a light-emitting surface provided with a plurality of conductive terminals. The socket includes a body having a lengthwise slot for receiving the light-emitting disk, a plug and a plurality of solder bumps placed in the slot for electrically connecting the plug. When the light-emitting disk is inserted into the slot, the plurality of conductive terminals and solder bumps are conducted to excite the light-emitting disk to luminescent.

### BRIEF DESCRIPTION OF THE DRAWINGS

The present invention will be described according to the appended drawings in which:

FIGS. 1(a) and (b) show light-emitting disks according to embodiments of the present invention;

FIGS. 2(a)˜2(e) are different views of a socket according to first embodiment of the present invention;

FIG. 3(a) shows a combination of a socket and a light-emitting disk according to a first embodiment of the present invention;

FIG. 3(b) is a cross-sectional view taken along A-A′ line of FIG. 3(a);

FIGS. 4(a) and (b) are schematic diagrams of the internal structure of the socket according to the present invention;

FIG. 5 shows a socket according to a second embodiment of the present invention; and

FIG. 6 shows a socket according to a third embodiment of the present invention.

### PREFERRED EMBODIMENT OF THE PRESENT INVENTION

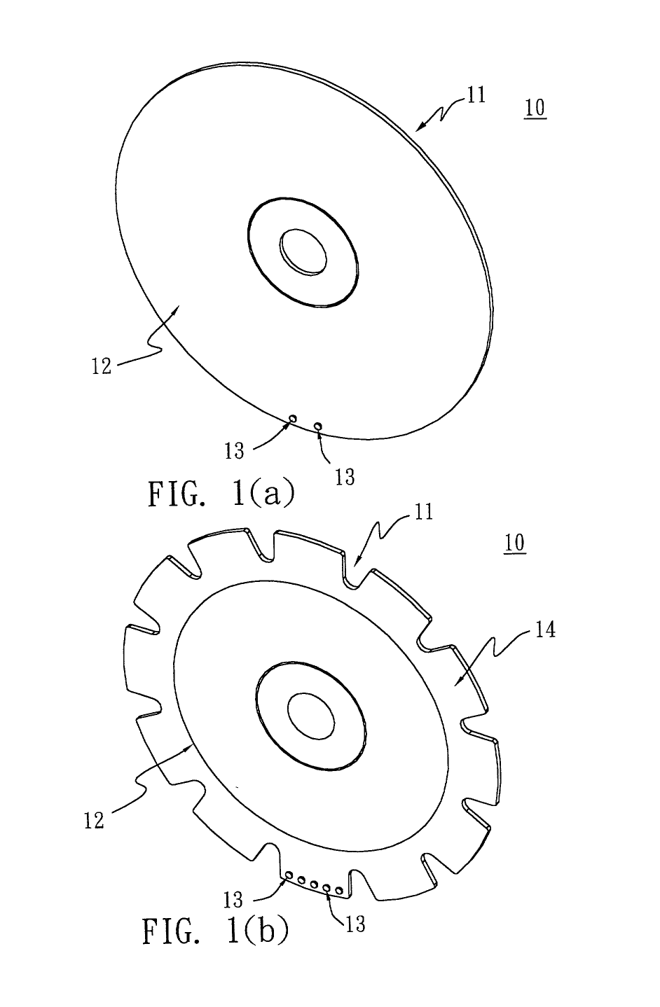

FIGS. 1(a) and (b) show light-emitting disks according to embodiments of the present invention. The light-emitting disk disclosed in the U.S. Pat. application Ser. No. 09/399,326 mentioned above is only an embodiment invented by the inventor. The present invention does not limit the process or structure of the light-emitting disk, and all the light-emitting disks whose one side (readable surface) is used to record data and another side (light-emitting surface) is used for illumination by applying external electricity are suitable to the present invention. Besides, the readable surface of the light-emitting disk still has the recording function, such as prior CD-ROM, CD-R, CD-RW, DVD-ROM, DVD-R, DVD-RW and MD, etc., and the light-emitting disk still has various shapes, such as a shape of heart and ellipse or other irregular shapes. The light-emitting disk can emit light partially, intermittently, and with various colors. The shape of the light-emitting disk in FIG. 1(a) is circle, and two conductive terminals 13 are placed on the light-emitting surface 12. When external electricity is applied to these two conductive terminals, the light-emitting surface 12 will be excited to luminesce. The light-emitting disk in FIG. 1(b) has a rim having a plurality of protruded regions 14, and a plurality of conductive terminals 13 are placed on the light-emitting surface 12. One of the conductive terminals can serve as a voltage reference point, and other conductive terminals are used to turn on or turn off illumination of corresponding protruded regions. External electricity can be applied to the plurality of conductive terminals and voltage reference point for lighting the light-emitting disk partially, intermittently or with various colors.

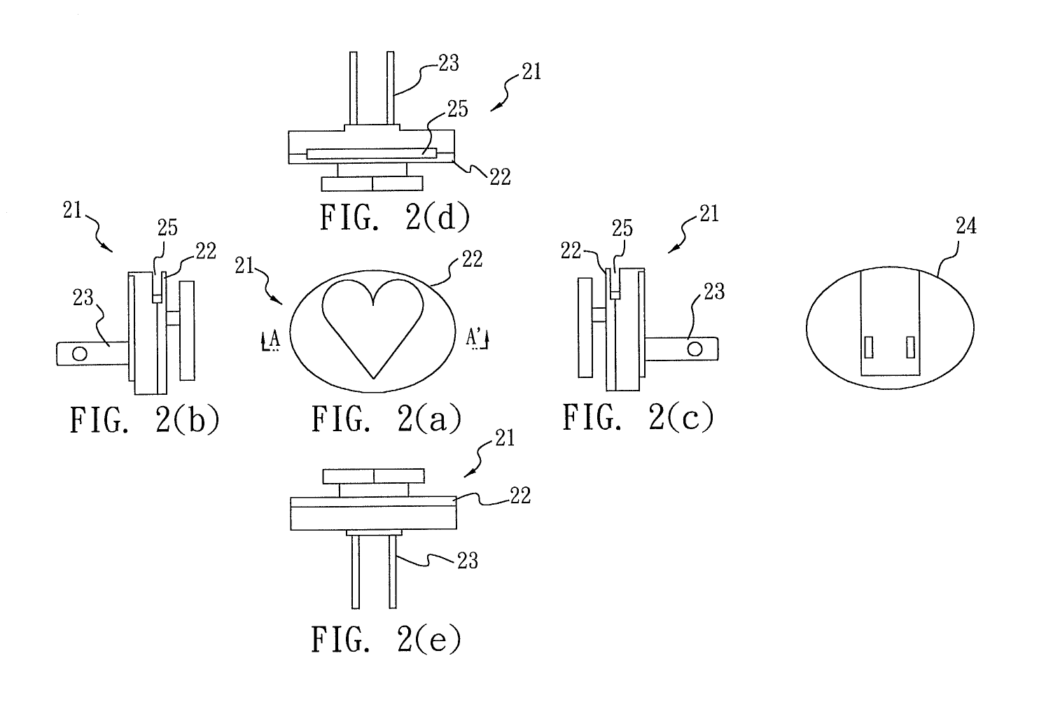

FIGS. 2(a)˜(e) show front, left side, right side, top and bottom views of a socket 21 according to the present invention. The socket 21 comprises a body 22 and a plug 23 coupled to the body 22. The plug 23 can rotate to both sides of the body along an axis on the boundary between the body 22 and plug 23, and it is convenient for users to insert the plug into an indoor socket 24 on the wall or on an extension line in any angle. Besides, a lengthwise slot is disposed on the top surface of the body 22 to insert the light-emitting disk therein.

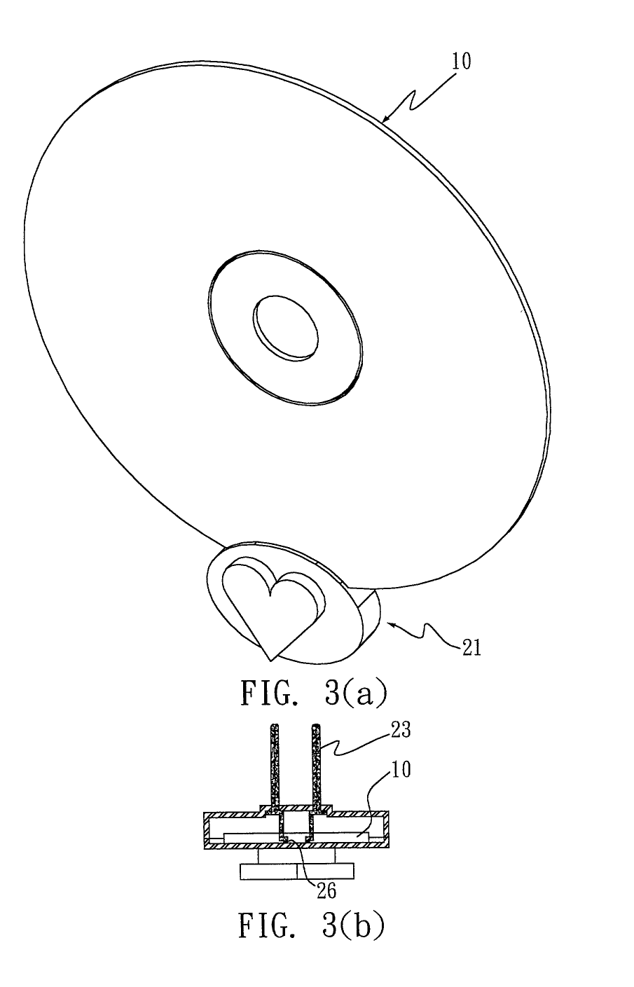

FIG. 3(a) shows a combination of a socket and a light-emitting disk of a first embodiment of the present invention. First, a user can rotate those two conductive terminals of the light-emitting disk 10 to an upright position, and then vertically insert the light-emitting disk 10 into the slot 25 of the body 22. FIG. 3(b) shows a cross-sectional view taken along A-A′ line of FIG. 3(a). The most important issue in combination of the disk and socket is whether these two conductive terminals contact well with solder bumps 26 on the disk. The contact is made by natural pressure or an elastic structure such as a spring leaf (not shown) between the plurality of conductive terminals and the solder bumps to ensure good conductivity. The solder bumps 26 are directly or indirectly electrically connected to the plug 23, so that the light-emitting disk will obtain external electricity through the indoor socket to luminesce. A dovetail (not shown) is designed inside the socket 21 for helping the users to align the two conductive terminals 13 with the solder bump 26 easily. Of course, after inserting the light-emitting disk 10 into the socket 21, users can clockwise or counterclockwise rotate the light-emitting disk 10 until the disk is located at the right position for illumination.

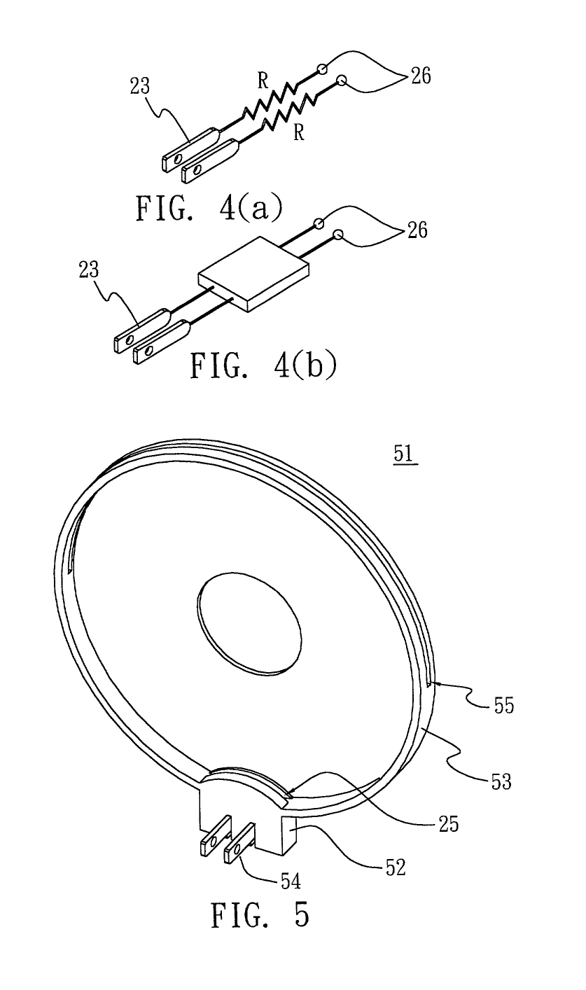

FIGS. 4(a) and (b) are schematic diagrams of the internal structure of the socket according to the present invention. The socket of the present invention is suitable for a typical indoor power of 110V˜120V and 50Hz˜60 Hz or 220V˜240V and 90Hz˜150 Hz. The present invention can further comprises resistors or capacitors, such as shown in FIG. 4(a), for use with the European specification of 220V˜240V and 50Hz˜60 Hz. As shown in FIG. 4(b), an inverter 27 is used with the plug of the present invention in order to be suitable for electricity of 60V˜150V and 50Hz˜2 KHz.

FIG. 5 shows a socket 51 according to a second embodiment of the present invention. The socket 51 comprises a body 52, a mask 53 and a plug 54. The structures and functions of the body 52 and plug 54 are almost the same with those in the first embodiment, and the most difference is that this embodiment comprises a mask 53 for the body 52. The mask 53 is made of a transparent material for preventing the light-emitting disk from being polluted by dust and humidity. Besides, a special material can be selected to soften the emitting light. The body 52 and mask 53 can be integrated into a single piece or assembled together and the present invention does not limit it. Furthermore, a lengthwise slot 55 on the top surface of the mask 53 is used to hold the light-emitting disk 10, and the mask 53 has a circular hole whose diameter is larger than the circular hole of the light-emitting disk 10.

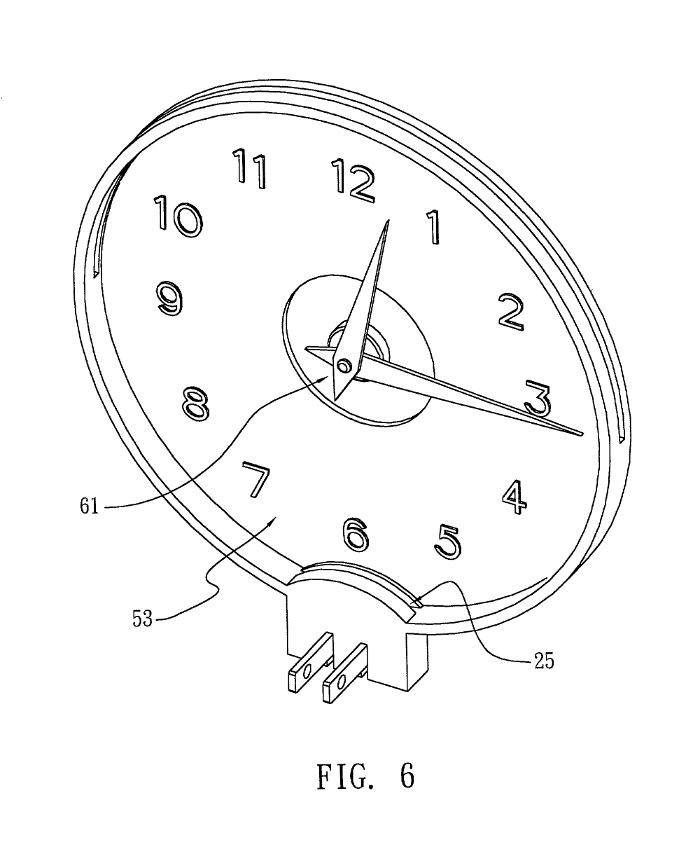

FIG. 6 shows a socket according to a third embodiment of the present invention. In this embodiment, the mask 53 is shaped as a clock. A control box including an oscillator and control circuit (not shown) of the clock could be fixed or assembled on a first side of the mask 53. After inserting the light-emitting disk, a user can extend a shaft 61 through the circular hole to the reverse side of the disk to control the movement of an hour pointer and minute pointer of a driving mechanism disposed inside the control box. By the above arrangement, the dimmer light utilized with the light-emitting disk of the present invention can increase one function to act as a clock. In addition, the function as a clock can be improved by adding a LCD panel (not shown) instead of the original hour pointer and minute pointer. Furthermore, a perfume bottle can be placed on the top surface of the mask for eliminating the odor. A photoresistor (not shown) can be placed inside the body to act as a power switch which cuts off circuit in daytime to save energy.

The above-described embodiments of the present invention are intended to be illustrative only. Numerous alternative embodiments may be devised by those skilled in the art without departing from the scope of the following claims.

What is claimed is:

1. A dimmer light for use with a light-emitting disk, comprising:
a light-emitting disk including: a readable surface, and a light-emitting surface provided with a plurality of conductive terminals; and
a socket including: a body having a lengthwise slot for receiving the light-emitting disk, a plug and a plurality of solder bumps placed in the slot for electrically connecting the plug;
wherein when the light-emitting disk is inserted into the slot, the plurality of conductive terminals and solder bumps are conducted to excite the light-emitting disk to luminesce.

2. The dimmer light of claim 1, further comprising an elastic means placed between the plurality of conductive terminals and solder bumps to increase conductivity by oppressing.

3. The dimmer light of claim 1, wherein said plug can be rotated to both sides of the body along an axis on the boundary between the body and the plug.

4. The dimmer light of claim 1, further comprising:
a transparent mask covering the body, and a slot located on the top surface of the mask for receiving the light-emitting disk.

5. The dimmer light of claim 4, wherein said mask and body are integrated into one single piece.

6. The dimmer light of claim 4, further comprising:
a clock control box having a driving mechanism placed on a first surface of the mask, a clock made on a second surface of the mask, a shaft extending through the disk to engage with the driving mechanism, wherein the clock has a hour pointer and minute pointer engaging one end of the shaft.

7. The dimmer light of claim 1, wherein said light-emitting disk lights partially, intermittently, or with different colors by applying external electricity to the plurality of conductive terminals.

8. The dimmer light of claim 1, wherein the plurality of solder bumps are electrically connected to the plug via resistors or capacitors.

9. The dimmer light of claim 1, wherein the plurality of solder bumps are electrically connected to the plug via an inverter.

10. The dimmer light of claim 1, further comprising a dovetail inside the socket for facilitating aligning the plurality of conductive terminals with the solder bumps.

11. The dimmer light of claim 4, further comprising:
a clock control box placed on a first surface of the mask, and a LCD panel placed on a second surface of the mask for showing the current time.

12. The dimmer light of claim 1, further comprising at least one photoresistor for acting as a circuit switch, the photoresistor cutting off the electricity of circuit connection in daytime for saving power consumption.

13. The dimmer light of claim 4, further comprising a perfume box placed on the top of the mask.

14. A socket for use with a light-emitting disk, having a plurality of conductive terminals placed on a light-emitting surface of the light-emitting disk, said socket comprising:
a body having: a lengthwise slot at its top surface for receiving the light-emitting disk, and a plurality of solder bumps placed on the slot; and
a plug coupled to the body and electrically connected to the plurality of solder bumps in the body;
wherein when the light-emitting disk is inserted into the slot, the plurality of conductive terminals and solder bumps are conducted to excite the light-emitting disk to luminesce.

15. The socket of claim 14, wherein said plug can be rotated to both sides of the body along an axis on the boundary between the body and the plug.

16. The socket of claim 14, further comprising:
a transparent mask lovering the body, and a slot located on the top surface of the mask for receiving the light-emitting disk.

17. The socket of claim 16, wherein said mask and body are integrated into one single piece.

18. The socket of claim 16, further comprising:
a clock control box having a driving mechanism placed on a first surface of the mask, a clock made on a second surface of the mask, a shaft extending through the disk to engage with the mechanism wherein the clock has a hour pointer and minute pointer engaging one end of the shaft.

19. The socket of claim 14, wherein the plurality of solder bumps are electrically connected to the plug via resistors or capacitors.

20. The socket of claim 14, wherein the plurality of solder bumps are electrically connected to the plug via an inverter.

21. The socket of claim 14, further comprising a dovetail inside the socket for facilitating aligning the plurality of conductive terminals with the solder bumps.

22. The socket of claim 14, further comprising an elastic means placed between the plurality of conductive terminals and solder bumps to increase conductivity by oppressing.

23. The socket of claim 16, further comprising a perfume box placed on the top of the mask.

24. The socket of claim 16, wherein a clock control box is placed on a first surface of the mask and a LCD panel for showing the current time is placed on a second surface of the mask.

25. The socket of claim 14, further comprising at least one photoresistor for acting as a circuit switch, the photoresistor cutting off the electricity of circuit in daytime for saving power consumption.
